(19) United States
(12) Patent Application Publication
(10) Pub. No.: US 2016/0188846 A1
(43) Pub. Date: Jun. 30, 2016

(54) DIGITAL RESOURCE PUBLICATION AND DISTRIBUTION SYSTEM AND METHOD

(71) Applicant: XIAMEN GEEBOO INFORMATION TECHOLOGY CO. LTD., Xiamen (CN)

(72) Inventor: Jinxu HUANG, Xiamen (CN)

(73) Assignee: Xiamen Geeboo Information Technology Co. Ltd., Xiamen (CN)

(21) Appl. No.: 14/779,458

(22) PCT Filed: Jul. 3, 2012
(86) PCT No.: PCT/CN2012/078126

§ 371 Date: Sep. 23, 2015

(51) Int. Cl. G06F 21/10; G06Q 50/18; G06F 11/30

(52) U.S. Cl. CPC G06F 21/105; G06F 11/3003; G06Q 50/184; G06F 2221/0775

(57) ABSTRACT

A digital resources publication and distribution method comprises: a receiving step, for receiving the content information of digital resources to be distributed and the corresponding distributing quantity; a generation step, for generating as many unique copy identifiers as the distributing quantity; a determination step for determining, when a resource requester attempts to obtain the rights to use a first specified number of copies of the digital resources, whether the number of the unique copy identifiers not yet allocated among the unique copy identifiers of the distributing quantity is larger than or equal to the first specified number; an allocation step, for, when the determination result is positive, allocating to the resource requester the first specified number of unique copy identifiers from the unique copy identifiers not yet allocated, so that the resource requester has the rights to use the first specified number of copies of the digital resources.

### FIELD OF THE INVENTION

The present disclosure relates to the technical field of digital resources publication and distribution, and particularly to digital resources publication and distribution system and method.

### BACKGROUND OF THE INVENTION

In the publication and distribution platforms of digital resources at the present market, the settlement mode of one-time authorization is generally used. The copyright owners of electronic books (e-books) cannot know the sale and usage situations of the digital resources, and thus they are in a disadvantageous position of serious information asymmetry.

At present, during digital resources publication and distribution procedures, there is not a technical means for monitoring the distributing quantity in an effective manner. The distributors cannot know the sales quantity of the digital resources based on the supervision at the present level. Even some sales data is fed back to the distributor, the sales data cannot reflect the circulation situation of the digital resources in a real manner.

### SUMMARY OF THE INVENTION

The technical problem to be solved by the present disclosure is to provide a system and a method for digital resources publication and distribution, whereby the distributing quantity of the digital resources can be monitored better.

In order to solve the aforesaid technical problem, the present disclosure provides a method for publishing and distributing digital resources, comprising the following steps:

receiving, in a receiving step, content information of the digital resources to be distributed and a corresponding distributing quantity;

generating, in a generation step, as many unique copy identifiers as the distributing quantity;

determining, in a determination step, when a resource requester attempts to obtain the rights to use a first specified number of copies of the digital resources, whether the number of the unique copy identifiers not yet allocated among the unique copy identifiers of the distributing quantity is larger than or equal to the first specified number; and

allocating, in an allocation step, when a determination result of the determination step is positive, to the resource requester the first specified number of unique copy identifiers from the unique copy identifiers not yet allocated, so that the resource requester has the rights to use the first specified number of copies of the digital resources.

Preferably, the receiving step further comprises receiving the content information of the digital resources to be distributed, corresponding distributing modes, and distributing quantities corresponding to the distributing modes respectively;

the generation step further comprises generating, with respect to each distributing mode, the unique copy identifiers corresponding to the distributing mode, a number of the unique copy identifiers generated therein corresponding to the distributing mode being equal to a distributing quantity of the distributing mode; and

the distributing mode comprises at least one of a selling mode, a lending mode, and a leasing mode, a distributing quantity corresponding to the selling mode represents a number of the digital resources that can be sold, a distributing quantity corresponding to the lending mode represents a number of the digital resources that can be lent at a same time, and a distributing quantity corresponding to the leasing mode represents a number of the digital resources that can be leased at a same time.

Preferably, the method further comprises a checking step in which at least one of the following sub-steps is executed so as to check whether the unique copy identifiers allocated therein belong to the unique copy identifiers generated therein:

comparing the unique copy identifiers that are allocated through a selling method with the unique copy identifiers generated therein corresponding to the selling mode according to an instruction of a distributor;

comparing the unique copy identifiers that are allocated through a leasing method with the unique copy identifiers generated therein corresponding to the leasing mode according to the instruction of the distributor; and

comparing the unique copy identifiers that are allocated through a lending method with the unique copy identifiers generated therein corresponding to the lending mode according to the instruction of the distributor.

Preferably, the receiving step further comprises receiving, when the distributing mode is the lending mode or the leasing mode, a distributing period of the digital resources to be distributed corresponding to the lending mode or the leasing mode, the distributing period representing a duration during which the resource requester can borrow or lease the digital resources each time.

Preferably, the method further comprises de-allocating, in a de-allocation step, when the distributing mode is the lending mode or the leasing mode, if the rights to use a second specified number of copies of the digital resources are to be released, the second specified number of unique copy identifiers of the digital resources which are already allocated to the resource requester, the de-allocation step converting the second specified number of unique copy identifiers of the digital resources of the resource requester into a state of not being allocated.

Preferably, the method further comprises a checking step in which at least one of the following sub-steps is executed:

comparing the unique copy identifiers allocated therein with the unique copy identifiers generated therein according to an instruction of a distributor so as to check whether the unique copy identifiers allocated therein belong to the unique copy identifiers generated therein; and

comparing the distributing quantity with the number of the unique copy identifiers that are allocated according to the instruction of the distributor so as to check whether the number of the unique copy identifiers that are allocated is larger than the distributing quantity.

Preferably, the method further comprises receiving, in the receiving step, at least one of digital resources name, digital resources type, and digital resources price of the digital resources to be distributed.

Preferably, the method further comprises presenting, in a presenting step, information relating to the unique copy identifiers generated therein and at least one of the following pieces of information to the distributor:

information relating to the unique copy identifiers that are allocated and the resource requesters to whom the unique copy identifiers are allocated;

information relating to the unique copy identifiers that are not allocated;

a number of the unique copy identifiers that are not allocated and/or a number of the unique copy identifiers that are allocated;

information relating to a time when each of the unique copy identifiers is allocated to each resource requester; and

information relating to a price at which each of the unique copy identifiers is allocated to each resource requester.

Preferably, the method further comprises feeding back, in a feedback step, when receiving feedback information submitted to the distributor by the resource requester, the feedback information and information relating to the unique copy identifiers that are allocated to the resource requester to the distributor.

Preferably, the method further comprises comparing the unique copy identifiers that are fed back in the feedback step with the unique copy identifiers that are generated in the generation step so as to determine whether the same unique copy identifier is allocated to a plurality of resource requesters incorrectly.

According to another aspect of the present disclosure, the present disclosure further provides a system for publishing and distributing digital resources, comprising:

a receiving unit, used for receiving content information of the digital resources to be distributed and a corresponding distributing quantity;

a generation unit, used for generating as many unique copy identifiers as the distributing quantity;

a determination unit, used for determining, when a resource requester attempts to obtain the rights to use a first specified number of copies of the digital resources, whether the number of the unique copy identifiers not yet allocated among the unique copy identifiers of the distributing quantity is larger than or equal to the first specified number; and

an allocation unit, used for allocating, when a determination result of the determination unit is positive, to the resource requester the first specified number of unique copy identifiers from the unique copy identifiers not yet allocated, so that the resource requester has the rights to use the first specified number of copies of the digital resources.

Preferably, the receiving unit is further used for receiving the content information of the digital resources to be distributed, corresponding distributing modes, and distributing quantities corresponding to the distributing modes respectively;

the generation unit is further used for generating, with respect to each distributing mode, the unique copy identifiers corresponding to the distributing mode, a number of the unique copy identifiers generated therein corresponding to the distributing mode being equal to a distributing quantity corresponding to the distributing mode; and

the distributing mode comprises at least one of a selling mode, a lending mode, and a leasing mode, a distributing quantity corresponding to the selling mode represents a number of the digital resources that can be sold, a distributing quantity corresponding to the lending mode represents a number of the digital resources that can be lent, and a distributing quantity corresponding to the leasing mode represents a number of the digital resources that can be leased.

Preferably, the system further comprises a checking unit in which at least one of the following sub-steps is executed so as to check whether the unique copy identifiers allocated therein belong to the unique copy identifiers generated therein:

comparing the unique copy identifiers that are allocated through a selling method with the unique copy identifiers generated therein corresponding to the selling mode according to an instruction of a distributor;

comparing the unique copy identifiers that are allocated through a leasing method with the unique copy identifiers generated therein corresponding to the leasing mode according to the instruction of the distributor; and

comparing the unique copy identifiers that are allocated through a lending method with the unique copy identifiers generated therein corresponding to the lending mode according to the instruction of the distributor.

Preferably, the receiving unit is further used for receiving, when the distributing mode is the lending mode or the leasing mode, a distributing period of the digital resources to be distributed corresponding to the lending mode or the leasing mode that is submitted through a client end by the distributor, the distributing period representing a duration during which the resource requester can borrow or lease the digital resources each time.

Preferably, the system further comprises a de-allocation unit, used for de-allocating, when the distributing mode is the lending mode or the leasing mode, if the rights to use a second specified number of copies of the digital resources are to be released, the second specified number of unique copy identifiers of the digital resources which are already allocated to the resource requester, the de-allocation step converting the second specified number of unique copy identifiers of the digital resources of the resource requester into a state of not being allocated.

Preferably, the system further comprises a checking unit in which at least one of the following sub-steps is executed:

comparing the unique copy identifiers allocated therein with the unique copy identifiers generated therein according to an instruction of a distributor so as to check whether the unique copy identifiers allocated therein belong to the unique copy identifiers generated therein; and

comparing the distributing quantity with the number of the unique copy identifiers that are allocated according to the instruction of the distributor so as to check whether the number of the unique copy identifiers that are allocated is larger than the distributing quantity.

Preferably, the system further comprises a presenting unit, used for presenting information relating to the unique copy identifiers generated therein and at least one of the following pieces of information to the distributor:

information relating to the unique copy identifiers that are allocated and the resource requesters to whom the unique copy identifiers are allocated;

information relating to the unique copy identifiers that are not allocated;

a number of the unique copy identifiers that are not allocated and/or a number of the unique copy identifiers that are allocated;

information relating to a time when each of the unique copy identifiers is allocated to each resource requester; and

information relating to a price at which each of the unique copy identifiers is allocated to each resource requester.

Preferably, the system further comprises a feedback unit, used for feeding back, when receiving feedback information submitted to the distributor by the resource requester, the feedback information and information relating to the unique copy identifiers that are allocated to the resource requester to the distributor.

Preferably, the checking unit is further used for comparing the unique copy identifiers that are fed back by the feedback unit with the unique copy identifiers that are generated by the generation unit so as to determine whether the same unique copy identifier is allocated to a plurality of resource requesters incorrectly.

Compared with the prior art, one embodiment or a plurality of embodiments according to the present disclosure may have the following advantages. The rights to use the digital resources can be controlled through the unique copy identifiers, so that the number of copies of the digital resources can be controlled within the distributing quantity expected by the distributor. In this manner, the real distributing quantity of the digital resources can be monitored better, and even the circulation situation of the digital resources after being sold can be reflected by the real distributing quantity.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 is a flow chart of a method for publishing and distributing digital resources according to Embodiment 1 of the present disclosure;

FIG. 2 is a flow chart of a specific example of the method for publishing and distributing digital resources according to Embodiment 1 of the present disclosure;

FIG. 3 schematically shows a structure of a system for publishing digital resources according to Embodiment 2 of the present disclosure; and

FIG. 4 schematically shows an implementation architecture of a system for publishing digital resources according to Embodiment 3 of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no conflict, all the technical features mentioned in all the embodiments may be combined together in any manner, and the technical solutions obtained in this manner all fall within the scope of the present disclosure.

In addition, the steps as shown in the flow charts can be executed in a computer system by a group of computer executable instructions. Although the logical sequence is shown in the flow charts, the steps shown or described herein can be executed in other sequences different from the one shown herein in some cases.

### Embodiment 1

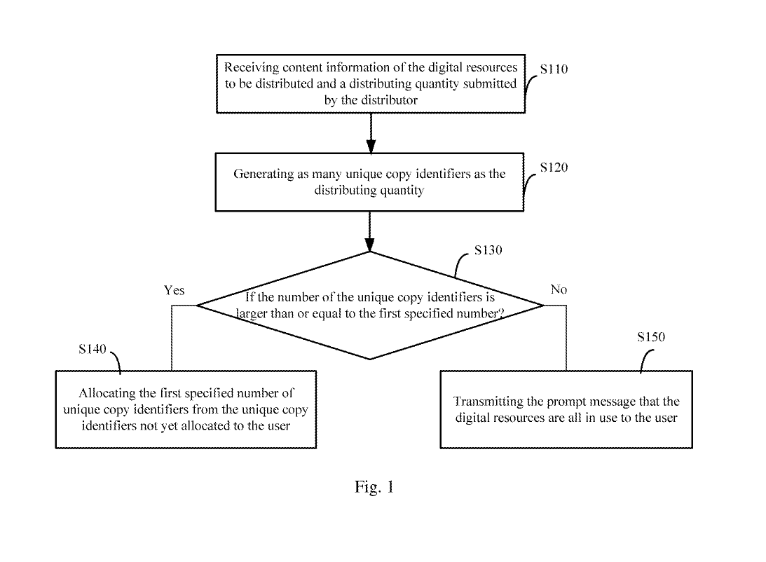

A location where a digital resources publication and distribution system according to the present embodiment is used during practices is first illustrated with reference to FIG. 1, so that the digital resources publication and distribution system and method can be understood by those skilled in the art.

Publishing houses, authors of books, musicians, providers or operators of digital resources, etc are connected with the digital resources publication and distribution system (also referred to as a distributing platform for short) through clients end, so that the digital resources can be distributed on the internet. In this case, the publishing houses, authors of books, musicians, providers or operators of digital resources, etc can provide users, third party cooperation platforms, and other resource requesters with network application services of selling, lending, or leasing the digital resources. Here, the lending refers to a service mode of providing the resource requesters with the rights to use the digital resources for free in a certain time period, such as free borrowing, free probation, or the users being able to borrow the digital resources for free after getting a membership card (after payment). For the sake of convenience, the present disclosure will be illustrated hereinafter taking the user serving as the resource requester as an example.

The steps of the method for publishing and distributing digital resources according to the present embodiment will be illustrated hereinafter with reference to FIG. 1.

In step S110, content information of the digital resources to be distributed and distributing quantity thereof submitted by a distributor through a client end, a third party distributing platform or system are received.

In step S120, as many unique copy identifiers as the distributing quantity are generated.

In step S130, when a user attempts to obtain the rights to use a first specified number of copies of the digital resources, whether the number of the unique copy identifiers not yet allocated among the unique copy identifiers of the distributing quantity is larger than or equal to the first specified number is determined. If a determination result is positive, step S140 is entered; otherwise, step S150 is entered.

In step S140, the first specified number of unique copy identifiers from the unique copy identifiers not yet allocated are allocated to the user, so that the user has the rights to use the first specified number of copies of the digital resources.

In step S150, the prompt message that the digital resources are all in use, such as the digital resources are sold out, leased or borrowed, is transmitted to the user.

Specifically, in step S110, the distributor can distribute the digital resources in the digital resources publication and distribution system (also referred to as the distributing platform for short) through browsers, intelligent terminals installed with network application services, and other client ends. The digital resources distributed therein include but not limited by audio, videos, electronic readings (newspapers and periodicals, magazines, as well as books), games, software, practical information or the combination of the above.

For example, if a book, as a digital resource, is to be distributed, the distributor uploads the contents of the book and information relating to the distributing quantity thereof through a browser. In other words, the distributor submits the contents of the book and the distributing quantity through the browser to the distribution platform in the cloud end. In this case, the content information of the digital resource to be distributed and the distributing quantity submitted by the distributor through the client end are received by the platform. The distributor can be the publishing house, the author of the book, the operator of the book, etc.

In step S120, as many unique copy identifiers as the distributing quantity are generated. The unique copy identifiers can be graphs or numbers, as long as each copy of the digital resource (hereinafter referred to as digital resource copy for short) to be distributed can be identified in a unique manner. Here, the digital resource copy can be a duplication of the digital resource uploaded by the distributor, or not a duplication of the digital resource uploaded by the distributor and only represented by the unique copy identifier generated therein. One unique copy identifier represents one copy, and therefore, the number of the unique copy identifiers is the distributing quantity allowed therein.

In step S130, when a user attempts to obtain the rights to use a first specified number of copies of the digital resource, whether the number of the unique copy identifiers not yet allocated among the unique copy identifiers that are generated in step S120 is larger than or equal to the first specified number is determined. If the determination result is positive, step S140 is entered, and the first specified number of unique copy identifiers are allocated to the user; otherwise, step S150 is entered, and the prompt message that the digital resource is sold or leased is transmitted to the user.

In step S140, the first specified number of unique copy identifiers from the unique copy identifiers not yet allocated are allocated to the user, so that the user has the rights to use the first specified number of copies of the digital resource. Specifically, if one unique copy identifier is allocated to the user, the user has the rights to use only one copy. For example, if the user places one copy of the digital resource to his tablet personal computer, the user is not allowed to duplicate the digital resource to his e-book reader through the distributing platform since he only has the rights to use one copy of the digital resource.

It can be seen that, if the user wants to have the rights to use one copy of the digital resource, one unique copy identifier must be allocated to him. Moreover, one unique copy identifier can only be allocated once. When a certain number of the unique copy identifiers are allocated to the user, the user is allowed to use the above number of copies of the digital resource.

It should be noted that, the user can use the digital resource through various methods. For example, the user can use a certain number of digital resources after the certain number of digital resources are sold, leased, or lent to the user.

In addition, during the allocation of the unique copy identifiers, state parameters of the unique copy identifiers can be set. The state parameters of the unique copy identifiers include “allocated” and “not allocated.” When one unique copy identifier is allocated, a state parameter thereof is changed into “allocated.”

Moreover, in step S110, digital resources name, digital resources type, and digital resources price of the digital resources to be distributed are received.

Furthermore, in order to facilitate the supervision of the digital resources distributed by the distributor, the distributing platform can, periodically or upon a request of the distributor, present to the distributor information relating to the unique copy identifiers generated therein and at least one of the following pieces of information: information relating to the unique copy identifiers that are allocated and the users to whom the unique copy identifiers are allocated, for example, the unique copy identifiers that are allocated and/or serial numbers thereof; information relating to the unique copy identifiers that are not allocated, for example, the unique copy identifiers that are not allocated and/or serial numbers thereof; a number of the unique copy identifiers that are not allocated and/or a number of the unique copy identifiers that are allocated; information relating to a time when each of the unique copy identifiers is allocated to each user, for example, to which user each unique copy identifier is allocated, the date and time when the unique copy identifier is allocated, when the usage rights shall be returned, etc; and information relating to a price at which each of the unique copy identifiers is allocated to each user, for example, the price of the digital resource or a discount thereof when each unique copy identifier is allocated to each user. In this case, the distributing platform is more transparent to the distributor, and the distributor can know sales quantity and target groups of the book clearly.

According to the present embodiment, in order to further improve the supervision efficiency of the digital resources distributed by the distributor, the digital resources publication and distribution method can further comprise a checking step in which at least one of the following sub-steps is executed: comparing the unique copy identifiers allocated therein with the unique copy identifiers generated therein according to an instruction of a distributor so as to check whether the unique copy identifiers allocated therein belong to the unique copy identifiers generated therein; and comparing the distributing quantity with the number of the unique copy identifiers that are allocated according to the instruction of the distributor so as to check whether the number of the unique copy identifiers that are allocated is larger than the distributing quantity. If it is discovered that the unique copy identifiers allocated therein do not belong to the unique copy identifiers generated therein, or that the number of the unique copy identifiers that are allocated is larger than the distributing quantity, warning information can be transmitted to the distributor or a system administrator.

Further, in order to avoid the situation that the distributing platform misleads the distributor through transmitting only part of the information relating to the unique copy identifiers that are allocated, or through presenting an incorrect comparison result to the distributor, so that the distributor trusts the distributing platform more, according to the present embodiment, the digital resources publication and distribution method can further comprise feeding back, in a feedback step, when receiving feedback information submitted to the distributor by the user, the feedback information and information relating to the unique copy identifiers that are allocated to the user to the distributor. Preferably, the method can further comprise comparing the unique copy identifiers that are fed back in the feedback step with the unique copy identifiers that are generated in the generation step so as to determine whether the same unique copy identifier is allocated to a plurality of users incorrectly.

In addition, in step S110, the content information of the digital resources to be distributed, corresponding distributing modes, and distributing quantities corresponding to the distributing modes respectively can be received as well.

And then, in step S120, with respect to each distributing mode, the unique copy identifiers corresponding to the distributing mode are generated. A number of the unique copy identifiers generated therein corresponding to the distributing mode is equal to a distributing quantity of the distributing mode. The distributing mode comprises at least one of a selling mode, a lending mode, and a leasing mode, a distributing quantity corresponding to the selling mode represents a number of the digital resources that can be sold, a distributing quantity corresponding to the lending mode represents a number of the digital resources that can be lent, and a distributing quantity corresponding to the leasing mode represents a number of the digital resources that can be leased.

In this case, the method can further comprise a checking step in which at least one of the following sub-steps is executed so as to check whether the unique copy identifiers allocated therein belong to the unique copy identifiers generated therein: comparing the unique copy identifiers that are allocated through a selling method with the unique copy identifiers generated therein corresponding to the selling mode according to an instruction of a distributor; comparing the unique copy identifiers that are allocated through a leasing method with the unique copy identifiers generated therein corresponding to the leasing mode according to the instruction of the distributor; and comparing the unique copy identifiers that are allocated through a lending method with the unique copy identifiers generated therein corresponding to the lending mode according to the instruction of the distributor.

In addition, when the distributing mode is the lending mode or the leasing mode, in step S110, a distributing period of the digital resources to be distributed corresponding to the lending mode or the leasing mode that is submitted by the distributor through a client end can be received. The distributing period represents a duration during which the user can borrow or lease the digital resources each time.

Moreover, when the distributing mode is the lending mode or the leasing mode, if the rights to use a second specified number of copies of the digital resources are to be released, i.e., to make that the user does not have the rights to use the second specified number of copies of the digital resources, the second specified number of unique copy identifiers of the digital resources which are already allocated to the user are de-allocated. In this case, the user does not have the rights to use the second specified number of copies of the digital resources any more, and the unique copy identifiers on which a de-allocation step is performed are converted into a state of not being allocated and can be allocated to other users once again.

For example, when the distributing mode is the lending mode, if one (corresponding to the second specified number) e-book is returned by a user, the unique copy identifier of the e-book that is originally allocated to the user is de-allocated. In this case, the unique copy identifier can be allocated to other users, which means that another user is allowed to borrow this e-book, i.e., the user has the rights to use one copy of the e-book within the distributing period.

It should be noted that, there are many methods through which a certain unique copy identifier is allocated to a certain user, or a certain unique copy identifier is de-allocated. For example, a state parameter and a user parameter can be set for the unique copy identifier. When the unique copy identifier is allocated to the user, the state parameter of the unique copy identifier is “allocated,” and the user parameter of the unique copy identifier is an identifier of the user. When the unique copy identifier is de-allocated, the state parameter of the unique copy identifier is “not allocated,” and the user parameter of the unique copy identifier is cleared.

In addition, the situation that the rights to use the copies of the digital resources are released is not limited by the situation that the user returns the digital resources, and can be the situations that the copies of the digital resources are lost, the rights to use the copies of the digital resources expire, etc.

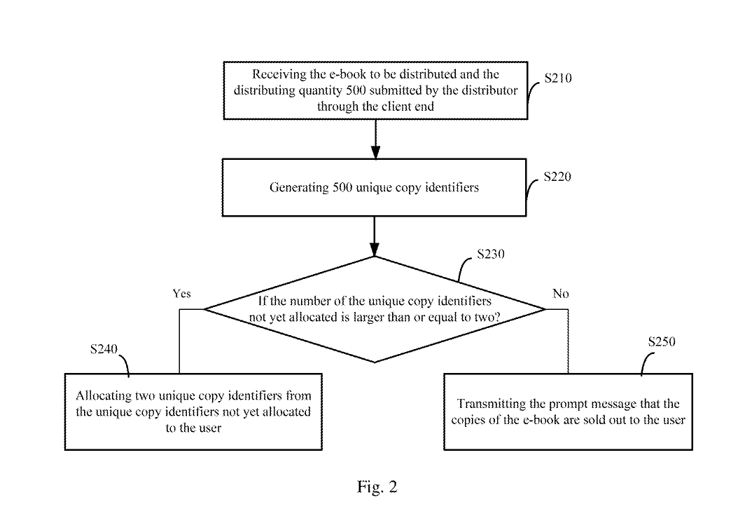

A specific example will be illustrated below with reference to FIG. 2, in which the following steps are executed.

In step S210, the e-book to be distributed (corresponding to the content information of the digital resources) and the distributing quantity 500 submitted by the distributor through the client end are received.

In step S220, 500 unique copy identifiers are generated.

In step S230, when the user wants to purchase two e-books, whether the number of the unique copy identifiers not yet allocated among the 500 unique copy identifiers is larger than or equal to two is determined. If a determination result is positive, step S240 is entered; otherwise, step S250 is entered.

In step S240, two unique copy identifiers from the unique copy identifiers not yet allocated are allocated to the user, so that the user has the rights to use two copies of the e-book. In this case, the e-book can be duplicated twice by the user, for example, one copy of the e-book can be placed to a mobile phone for reading, and another copy of the e-book can be placed to a tablet personal computer for reading. In step S250, the prompt message that the copies of the e-book are sold out is transmitted to the user.

### Embodiment 2

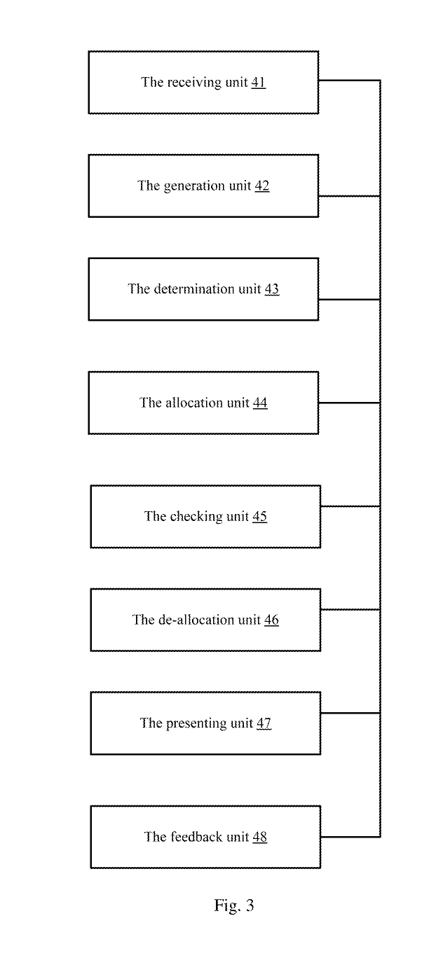

The digital resources publication and distribution system according to the present embodiment will be illustrated hereinafter with reference to FIG. 3. The system can comprise the following units:

a receiving unit 41, which is used for receiving content information of the digital resources to be distributed and a corresponding distributing quantity;

a generation unit 42, which is used for generating as many unique copy identifiers as the distributing quantity;

a determination unit 43, which is used for determining, when a resource requester attempts to obtain the rights to use a first specified number of copies of the digital resources, whether the number of the unique copy identifiers not yet allocated among the unique copy identifiers of the distributing quantity is larger than or equal to the first specified number; and

an allocation unit 44, which is used for allocating, when a determination result of the determination unit is positive, to the resource requester the first specified number of unique copy identifiers from the unique copy identifiers not yet allocated, so that the resource requester has the rights to use the first specified number of copies of the digital resources.

The functions of the receiving unit 41, the generation unit 42, the determination unit 43, and the allocation unit 44 correspond to the steps S110, S120, S130, and S140 in Embodiment 1 respectively, the details of which are no longer repeated here.

In addition, according to the present embodiment, the system can further comprise a checking unit 45, a de-allocation unit 46, a presenting unit 47, and a feedback unit 48.

The checking unit 45 is used for executing at least one of the following sub-steps: comparing the unique copy identifiers allocated therein with the unique copy identifiers generated therein according to an instruction of a distributor so as to check whether the unique copy identifiers allocated therein belong to the unique copy identifiers generated therein; and comparing the distributing quantity with the number of the unique copy identifiers that are allocated according to the instruction of the distributor so as to check whether the number of the unique copy identifiers that are allocated is larger than the distributing quantity.

Preferably, when the receiving unit receives the content information of the digital resources to be distributed, corresponding distributing modes, and distributing quantities corresponding to the distributing modes respectively, and when the generation unit generates, with respect to each distributing mode, the unique copy identifiers corresponding to the distributing mode, a number of the unique copy identifiers generated therein corresponding to the distributing mode being equal to a distributing quantity corresponding to the distributing mode, the checking unit executes at least one of the following sub-steps so as to check whether the unique copy identifiers allocated therein belong to the unique copy identifiers generated therein: comparing the unique copy identifiers that are allocated through a selling method with the unique copy identifiers generated therein corresponding to the selling mode according to an instruction of a distributor; comparing the unique copy identifiers that are allocated through a leasing method with the unique copy identifiers generated therein corresponding to the leasing mode according to the instruction of the distributor; and comparing the unique copy identifiers that are allocated through a lending method with the unique copy identifiers generated therein corresponding to the lending mode according to the instruction of the distributor.

The de-allocation unit 46 is used for de-allocating, when the distributing mode is the lending mode or the leasing mode, if the rights to use a second specified number of copies of the digital resources are to be released, the second specified number of unique copy identifiers of the digital resources which are already allocated to the resource requester, the de-allocation step converting the second specified number of unique copy identifiers of the digital resources of the resource requester into a state of not being allocated. In addition, the operations such as the user parameter being cleared can be executed.

The presenting unit 47 is used for presenting information relating to the unique copy identifiers generated therein and at least one of the following pieces of information to the distributor: information relating to the unique copy identifiers that are allocated and the resource requesters to whom the unique copy identifiers are allocated; information relating to the unique copy identifiers that are not allocated; a number of the unique copy identifiers that are not allocated and/or a number of the unique copy identifiers that are allocated; information relating to a time when each of the unique copy identifiers is allocated to each resource requester; and information relating to a price at which each of the unique copy identifiers is allocated to each resource requester.

The feedback unit 48 is used for feeding back, when receiving feedback information submitted to the distributor by the resource requester, the feedback information and information relating to the unique copy identifiers that are allocated to the resource requester to the distributor. In this case, the checking unit is further used for comparing the unique copy identifiers that are fed back by the feedback unit with the unique copy identifiers that are generated by the generation unit so as to determine whether the same unique copy identifier is allocated to a plurality of resource requesters incorrectly.

It should be noted that, the connection relationship as shown in FIG. 3 is just a preferred example, and the units can be connected through other methods. The units can even be connected through memories (not shown in FIG. 3) or wireless connection to exchange information instead of electrical connection.

### Embodiment 3

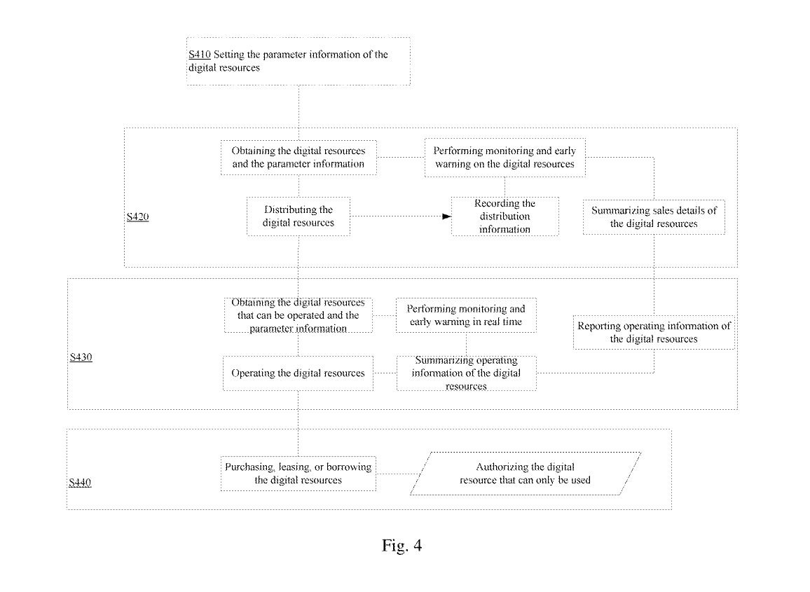

The implementing method and application of the digital resources publication and distribution system according to the present embodiment will be illustrated hereinafter with reference to FIG. 4.

In the following, during the application of the digital resources publication and distribution system according to the present embodiment, how the parameter information, distribution information, and sales information of the digital resources are set, collected, summarized, and supervised, whereby the circulation of the digital resources can be monitored and managed in a timely and effective manner will be illustrated in detail.

In step S410, the publication information is set. The parameter information of the digital resources is provided to the digital resources distributor through a client end, a web page, or a platform and the digital resources are uploaded. The data set therein can include resource types, distributing mode (such as selling, leasing or lending), distributing quantity, distributing price, and distributing period (during which the digital resources can be leased or lent).

In step S420, a distribution management is performed on the digital resources which are already published. The distribution management can include obtaining the digital resources and the parameter information thereof, distributing the digital resources, recording the distribution information, summarizing sales details of the digital resources, and performing monitoring and early warning on the digital resources in real time.

(1) Obtaining the digital resources that are published and the parameter information thereof: including resource types (such as e-books, magazines, audio, and videos), distributing mode, distributing quantity, distributing price, distributing period, etc.

(2) Distributing the digital resources: checking an obtaining request of an operator of the digital resources, and distributing the digital resources if the identification of the operator of the digital resources is approved.

(3) Recording the distribution information: when the digital resources are distributed, the identification information of the operator of the digital resources, the unique copy identifiers of the digital resources, the specific resource type, specific distributing mode, the quantity distributed to the operator, distributing price, distributing period, etc.

(4) Summarizing sales details of the digital resources: when the selling, leasing, or lending details are reported to the distributor of the digital resources from the operator of the digital resources, the distribution details of the digital resources shall be summarized and can be used during searching, statistics, monitoring, and early warning procedures.

(5) Performing monitoring and early warning on the digital resources in real time: comparing the distribution details of the distributor of the digital resources with the distribution information of all operators of the digital resources in real time, and issuing early warning signals when abnormal situations occur. The abnormal situations include the situation that the actual distributing quantity is larger than the allowed distributing quantity; the situation that the actually allocated unique copy identifier is different from the allowed unique copy identifier; and the situation that the copy of the digital resources which should be leased is sold incorrectly.

In step S430, the operator of the digital resources performs sales management on the digital resources, including obtaining the digital resources that can be operated and the parameter information thereof, operating the digital resources, reporting operating information of the digital resources, and performing monitoring and early warning in real time.

(1) Obtaining the digital resources that can be operated and the parameter information thereof: obtaining the digital resources and the corresponding parameter information from the digital resources distributor, including resource types, distributing mode, distributing quantity, distributing price, and distributing period.

(2) Operating the digital resources: checking a purchasing, leasing, or lending request of a user, authorizing the copy of the digital resources to the reader if it is determined that there are enough copies that can be sold, leased, or lent, and recording the sales details of the digital resources.

(3) Reporting operating information of the digital resources: when the digital resources are sold and the sales details are recorded, the sales details of the digital resources should be reported to the distributor of the digital resources, including the unique copy identifiers of the copies of the digital resources, information about the buyer, selling time, selling quantity, selling price, etc.

(4) Performing monitoring and early warning in real time: comparing the sales, leasing, or lending details of the digital resources with the information about the digital resources obtained therein in real time, and issuing early warning signals when abnormal situations occur. The abnormal situations include the situation that the actual distributing quantity is larger than the allowed distributing quantity; the situation that the actually allocated unique copy identifier is different from the allowed unique copy identifier; and the situation that the copy of the digital resources which should be leased is sold incorrectly.

In step S440, the user obtains the rights to use the digital resources through purchasing, leasing, or borrowing in a digital resources operation platform provided by the operator of the digital resources.

Apparently, it can be understood by those skilled in the art that, each of the modules and steps of the present disclosure can be realized with a general computing device. They can be centralized in one single computing device, or can be distributed in a network consisting of a plurality of computing devices. Optionally, they can be realized with program codes executable in computing devices, and can thus be stored in storage devices to be executed by the computing devices. Alternatively, they can be made into integrated circuit modules respectively, or a plurality of modules or steps of them can be made into one single integrated circuit module. In this manner, the present disclosure is not limited to any specific combination of hardware and software.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A method for publishing and distributing digital resources, comprising the following steps:
receiving, in a receiving step, content information of the digital resources to be distributed and a corresponding distributing quantity;
generating, in a generation step, as many unique copy identifiers as the distributing quantity;
determining, in a determination step, when a resource requester attempts to obtain the rights to use a first specified number of copies of the digital resources, whether the number of the unique copy identifiers not yet allocated among the unique copy identifiers of the distributing quantity is larger than or equal to the first specified number; and
allocating, in an allocation step, when a determination result of the determination step is positive, to the resource requester the first specified number of unique copy identifiers from the unique copy identifiers not yet allocated, so that the resource requester has the rights to use the first specified number of copies of the digital resources.

2. The method according to claim 1,
wherein the receiving step further comprises receiving the content information of the digital resources to be distributed, corresponding distributing modes, and distributing quantities corresponding to the distributing modes respectively;
wherein the generation step further comprises generating, with respect to each distributing mode, the unique copy identifiers corresponding to said distributing mode, a number of the unique copy identifiers generated therein corresponding to said distributing mode being equal to a distributing quantity of said distributing mode; and
wherein the distributing mode comprises at least one of a selling mode, a lending mode, and a leasing mode, wherein a distributing quantity corresponding to the selling mode represents a number of the digital resources that can be sold, a distributing quantity corresponding to the lending mode represents a number of the digital resources that can be lent at a same time, and a distributing quantity corresponding to the leasing mode represents a number of the digital resources that can be leased at a same time.

3. The method according to claim 2, further comprising a checking step in which at least one of the following sub-steps is executed so as to check whether the unique copy identifiers allocated therein belong to the unique copy identifiers generated therein:
comparing the unique copy identifiers that are allocated through a selling method with the unique copy identifiers generated therein corresponding to the selling mode according to an instruction of a distributor;
comparing the unique copy identifiers that are allocated through a leasing method with the unique copy identifiers generated therein corresponding to the leasing mode according to the instruction of the distributor; and
comparing the unique copy identifiers that are allocated through a lending method with the unique copy identifiers generated therein corresponding to the lending mode according to the instruction of the distributor.

4. The method according to claim 2, wherein the receiving step further comprises:
receiving, when the distributing mode is the lending mode or the leasing mode, a distributing period of the digital resources to be distributed corresponding to the lending mode or the leasing mode, the distributing period representing a duration during which the resource requester can borrow or lease the digital resources each time.

5. The method according to claim 2, further comprising:
de-allocating, in a de-allocation step, when the distributing mode is the lending mode or the leasing mode, if the rights to use a second specified number of copies of the digital resources are to be released, the second specified number of unique copy identifiers of the digital resources which are already allocated to the resource requester, the de-allocation step converting the second specified number of unique copy identifiers of the digital resources of the resource requester into a state of not being allocated.

6. The method according to claim 1, further comprising a checking step in which at least one of the following sub-steps is executed:
comparing the unique copy identifiers allocated therein with the unique copy identifiers generated therein according to an instruction of a distributor so as to check whether the unique copy identifiers allocated therein belong to the unique copy identifiers generated therein; and
comparing the distributing quantity with the number of the unique copy identifiers that are allocated according to the instruction of the distributor so as to check whether the number of the unique copy identifiers that are allocated is larger than the distributing quantity.

7. The method according to claim 1, further comprising:
receiving, in the receiving step, at least one of digital resources name, digital resources type, and digital resources price of the digital resources to be distributed.

8. The method according to claim 1, further comprising presenting, in a presenting step, information relating to the unique copy identifiers generated therein and at least one of the following pieces of information to the distributor:
information relating to the unique copy identifiers that are allocated and the resource requesters to whom the unique copy identifiers are allocated;
information relating to the unique copy identifiers that are not allocated;
a number of the unique copy identifiers that are not allocated and/or a number of the unique copy identifiers that are allocated;
information relating to a time when each of the unique copy identifiers is allocated to each resource requester; and
information relating to a price at which each of the unique copy identifiers is allocated to each resource requester.

9. The method according to claim 1, further comprising:
feeding back, in a feedback step, when receiving feedback information submitted to the distributor by the resource requester, the feedback information and information relating to the unique copy identifiers that are allocated to the resource requester to the distributor.

10. The method according to claim 9, further comprising:
comparing the unique copy identifiers that are fed back in the feedback step with the unique copy identifiers that are generated in the generation step so as to determine whether the same unique copy identifier is allocated to a plurality of resource requesters incorrectly.

11. A system for publishing and distributing digital resources, comprising:
a receiving unit, used for receiving content information of the digital resources to be distributed and a corresponding distributing quantity;
a generation unit, used for generating as many unique copy identifiers as the distributing quantity;
a determination unit, used for determining, when a resource requester attempts to obtain the rights to use a first specified number of copies of the digital resources, whether the number of the unique copy identifiers not yet allocated among the unique copy identifiers of the distributing quantity is larger than or equal to the first specified number; and
an allocation unit, used for allocating, when a determination result of the determination unit is positive, to the resource requester the first specified number of unique copy identifiers from the unique copy identifiers not yet allocated, so that the resource requester has the rights to use the first specified number of copies of the digital resources.

12. The system according to claim 11,
wherein the receiving unit is further used for receiving the content information of the digital resources to be distributed, corresponding distributing modes, and distributing quantities corresponding to the distributing modes respectively;
wherein the generation unit is further used for generating, with respect to each distributing mode, the unique copy identifiers corresponding to the distributing mode, a number of the unique copy identifiers generated therein corresponding to the distributing mode being equal to a distributing quantity corresponding to the distributing mode; and
wherein the distributing mode comprises at least one of a selling mode, a lending mode, and a leasing mode, a distributing quantity corresponding to the selling mode represents a number of the digital resources that can be sold, a distributing quantity corresponding to the lending mode represents a number of the digital resources that can be lent, and a distributing quantity corresponding to the leasing mode represents a number of the digital resources that can be leased.

13. The system according to claim 12, further comprising a checking unit in which at least one of the following sub-steps is executed so as to check whether the unique copy identifiers allocated therein belong to the unique copy identifiers generated therein:
comparing the unique copy identifiers that are allocated through a selling method with the unique copy identifiers generated therein corresponding to the selling mode according to an instruction of a distributor;
comparing the unique copy identifiers that are allocated through a leasing method with the unique copy identifiers generated therein corresponding to the leasing mode according to the instruction of the distributor; and
comparing the unique copy identifiers that are allocated through a lending method with the unique copy identifiers generated therein corresponding to the lending mode according to the instruction of the distributor.

14. The system according to claim 12, wherein the receiving unit is further used for receiving, when the distributing mode is the lending mode or the leasing mode, a distributing period of the digital resources to be distributed corresponding to the lending mode or the leasing mode that is submitted through a client end by the distributor, the distributing period representing a duration during which the resource requester can borrow or lease the digital resources each time.

15. The system according to claim 12, further comprising a de-allocation unit, used for de-allocating, when the distributing mode is the lending mode or the leasing mode, if the rights to use a second specified number of copies of the digital resources are to be released, the second specified number of unique copy identifiers of the digital resources which are already allocated to the resource requester, the de-allocation step converting the second specified number of unique copy identifiers of the digital resources of the resource requester into a state of not being allocated.

16. The system according to claim 11, further comprising a checking unit in which at least one of the following sub-steps is executed:
comparing the unique copy identifiers allocated therein with the unique copy identifiers generated therein according to an instruction of a distributor so as to check whether the unique copy identifiers allocated therein belong to the unique copy identifiers generated therein; and
comparing the distributing quantity with the number of the unique copy identifiers that are allocated according to the instruction of the distributor so as to check whether the number of the unique copy identifiers that are allocated is larger than the distributing quantity.

17. The system according to claim 11, further comprising a presenting unit, used for presenting information relating to the unique copy identifiers generated therein and at least one of the following pieces of information to the distributor:
information relating to the unique copy identifiers that are allocated and the resource requesters to whom the unique copy identifiers are allocated;
information relating to the unique copy identifiers that are not allocated;
a number of the unique copy identifiers that are not allocated and/or a number of the unique copy identifiers that are allocated;
information relating to a time when each of the unique copy identifiers is allocated to each resource requester; and
information relating to a price at which each of the unique copy identifiers is allocated to each resource requester.

18. The system according to claim 11, further comprising a feedback unit, used for feeding back, when receiving feedback information submitted to the distributor by the resource requester, the feedback information and information relating to the unique copy identifiers that are allocated to the resource requester to the distributor.

19. The system according to claim 18, wherein the checking unit is further used for comparing the unique copy identifiers that are fed back by the feedback unit with the unique copy identifiers that are generated by the generation unit so as to determine whether the same unique copy identifier is allocated to a plurality of resource requesters incorrectly.
